(19) United States
(12) Patent Application Publication
(10) Pub. No.: US 2020/0398360 A1
(43) Pub. Date: Dec. 24, 2020

(54) SYSTEM AND METHOD FOR FORMING A WELD ALONG A LENGTH

(71) Applicant: TWB Company, LLC, Monroe, MI (US)

(72) Inventors: WAYNE HUISMAN, MONROE, MI (US); DUSTIN MARSHALL, MONROE, MI (US); TOM LUZANSKI, MONROE, MI (US); YURI HOVANSKI, PROVO, UT (US)

(21) Appl. No.: 16/910,124

(22) Filed: Jun. 24, 2020

Related U.S. Application Data
(60) Provisional application No. 62/865,371, filed on Jun. 24, 2019.
(60) Provisional application No. 62/956,684, filed on Jan. 3, 2020.

(51) Int. Cl. B23K 9/007; B23K 26/244; B23K 9/02

(52) U.S. Cl. CPC B23K 9/007; B23K 9/02; B23K 26/244

(57) ABSTRACT

A technique for creating a weld along a joint. A method begins by positioning a first edge of a first member proximate to a second edge of a second member to form the joint, wherein the joint is to be welded along the length from a first position on the joint to a second position on the joint. A clamping ring of a refill spot welding apparatus is placed to surround an unwelded portion of the length. The clamping ring contacts a top surface of the first member and a top surface of the second member. A first refill spot weld process is performed with the refill spot welding apparatus to join the first member and the second member at a first spot weld on the joint.

### CROSS-REFERENCE TO RELATED APPLICATIONS

This application relates to and claims the benefit of U.S. Provisional Patent Application Ser. No. 62/865,371 filed on Jun. 24, 2019 entitled “SYSTEM AND METHOD FOR COMPLETING A WELD ALONG A LENGTH”, and U.S. Provisional Patent Application Ser. No. 62/956,684 filed on Jan. 3, 2020 entitled “SYSTEM AND METHOD FOR FORMING A WELD ALONG A LENGTH”, which are incorporated herein by reference in their entireties.

### TECHNICAL FIELD

In general, the present invention relates to tailored metal blanks and, in particular, a technique for completing a weld along a length during production of the tailored metal blanks.

### BACKGROUND

Metal blanks, and in particular sheet metal blanks, may be manufactured for a particular application. For example, tailored metal blanks are often created for various applications in the automotive industry. Such tailored metal blanks may be created by joining two or more metal blanks together via a welding process or other joining process. Often, the welding process used to join the two or more metal blanks creates a weld that ends prior to the end of the joint. Such welds that are not fully incorporated to the end of the joint can cause problems with the integrity and strength of the weld joint.

### SUMMARY

This summary is provided herein to help enable a general understanding of various aspects of exemplary, non-limiting embodiments that follow in the more detailed descriptions and the accompanying drawings. This summary is not intended, however, as an extensive or exhaustive overview. Instead, the sole purpose of the summary is to present some concepts related to some exemplary non-limiting embodiments in a simplified form as a prelude to the more detailed description of the various embodiments that follow.

In various, non-limiting embodiments, a technique is provided for forming a weld for a length of a joint. The technique includes positioning a first edge of a first member proximate to a second edge of a second member to form the joint, wherein the joint is to be welded along the length from a first position on the joint to a second position on the joint. A clamping ring of a refill spot welding apparatus is placed to surround an unwelded portion of the length. The clamping ring contacts a top surface of the first member and a top surface of the second member. A first refill spot weld process is performed with the refill spot welding apparatus to join the first member and the second member at a first spot weld on the joint.

In another embodiment, a method for forming a weld includes positioning a first edge of a first member proximate to a second edge of a second member to form a joint, where the joint is to be welded along a length from a first position on the joint to a second position on the joint. A welding process is performed to form the weld on the joint along a portion of the length, where the weld includes a retract hole. Additional material is placed on top of the retract hole. A clamp ring of a refill spot welding apparatus is placed to surround the additional material and the retract hole. A refill spot weld process is performed with the refill spot welding apparatus to fill the retract hole with material from the additional material.

In another embodiment, a method for forming a weld for a length of a joint includes positioning a first edge of a first member proximate to a second edge of a second member to form the joint. At least one clamping ring of a refill spot welding apparatus is placed to surround an unwelded portion of the length, where the clamping ring contacts a top surface of the first member and a top surface of the second member. At least one refill spot weld process is performed with the refill spot welding apparatus to join the first member and the second member at one or more spot welds on the joint.

These and other features of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 is a perspective view of a pair of components being positioned in a refill spot welding apparatus;

FIG. 2 is a top view of a weld that is not completed along a length of the weld joint;

FIG. 3 is a bottom view of a weld that is not completed along a length of the weld joint;

FIG. 4 is a cross-sectional view of an exemplary refill spot welding apparatus;

FIG. 5 illustrates a flow diagram of an exemplary, non-limiting embodiment for completing a weld for a length of a joint between two members;

FIG. 6 is a perspective view of a refill spot welding apparatus clamp ring being locked down at an unwelded portion of a weld joint between the pair of members;

FIG. 7 is a perspective view of a refill spot welding process performed on the weld joint between the pair of members;

FIG. 8 is a perspective view of the refill spot welding tool prior to retracting the clamp ring;

FIG. 9 is a perspective view of the completed weld after the refill spot welding process;

FIG. 10 is a top view of a weld having a retract hole;

FIG. 11 is a bottom view of a weld having a retract hole;

FIG. 12 illustrates a flow diagram of an exemplary, non-limiting embodiment for filling a retract hole in a weld; and

FIG. 13 is a top view of weld joints with filled retract holes

FIG. 14 is a top view of members arranged to form a joint;

FIG. 15 is a top view of a first spot weld formed on a joint;

FIG. 16 is a top view of a first set of spot welds formed along a joint;

FIG. 17 is a top view of a first set of spot welds and a second spot weld formed along a joint;

FIG. 18 is a top view of a first set of spot welds and a second set of spot welds formed along the entire length of a joint;

FIG. 19 is a top view of a first end spot weld and a second end spot weld formed on a joint

FIG. 20 illustrates a flow diagram of an exemplary, non-limiting embodiment for forming a weld along a length of a joint.

### DETAILED DESCRIPTION

A tailored blank formed from multiple pieces (e.g. metal blanks) has many applications, specifically within the automotive industry and in general various manufacturing industries. However, certain techniques used to join the multiple pieces can leave an unwelded portion at the edge of a weld joint. It is to be appreciated that when joined via certain processes the systems and methods can leave a section of inadequately joined material. For example, the area that can be welded may be different than the remainder of the seam using a plunge and retract of the weld. In accordance with various techniques described herein, an end welding technique and system is used to complete a weld for a length of a joint. In certain other embodiments, a refill spot welding process can be applied at multiple locations along a length of a joint to combine pieces together.

These and other advantages of the techniques provided herein will be apparent to one of ordinary skill in the art.

With reference to the drawings, like reference numerals designate identical or corresponding parts throughout the several views. The inclusion of like elements in different views does not mean a given embodiment necessarily includes such elements or that all embodiments of the invention include such elements. The examples and figures are illustrative only and not meant to limit the invention, which is measured by the scope and spirit of the claims. Moreover, it should be understood that the drawings may not depict features to scale. The drawings may enlarge or exaggerate certain features to facilitate visualization.

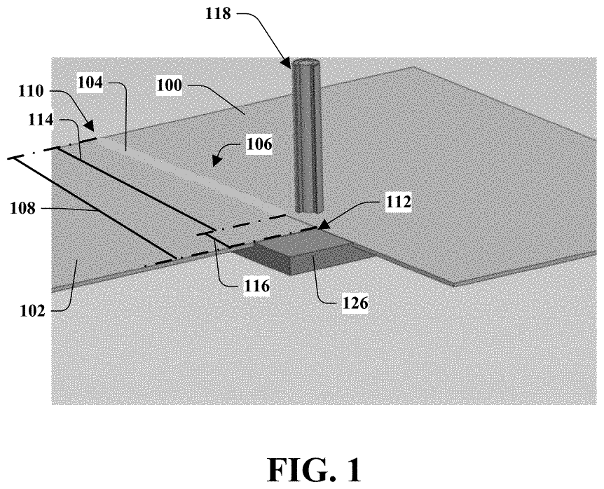

FIG. 1 depicts a first member 100 and a second member 102 joined together by a weld 104 at a joint. Each of the first member 100 and the second member 102 can be made of a metal including, but not limited to, aluminum, steel, stainless steel, nickel, copper, titanium, cast iron, a metal alloy, or a combination of different metals. Each of the first member 100 and the second member 102 can include a respective shape, size, length, thickness, height, width, surface finish, among others. The first member 100 and the second member 102 can be made of the same material or they can be made of different materials. In certain embodiments, the first member 100 and the second member 102 can together form a tailored blank. For example, the tailored blank can be formed from two or more members, wherein the members are joined by a welding operation. It is to be appreciated that the tailored blank can include a shape and each member that forms the tailored blank can include respective properties (e.g., shape, size, length, width, height, weight, thickness, composition, surface finish, surface pattern, etc.). The systems and methods described herein facilitate fabricating a tailored blank with one or more welds while mitigating discontinuities, defects and other welding issues.

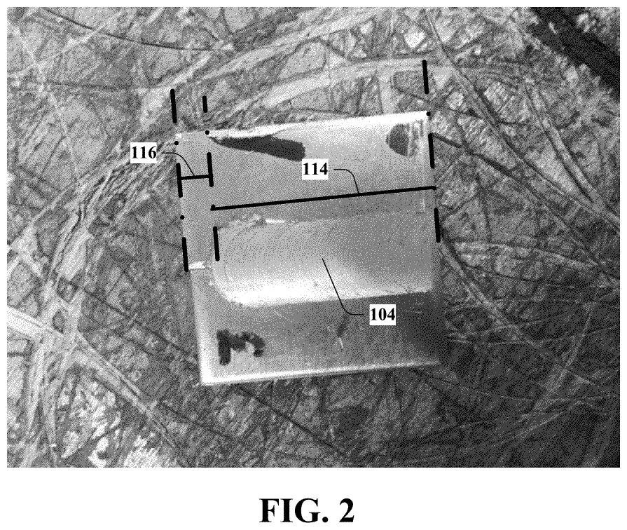

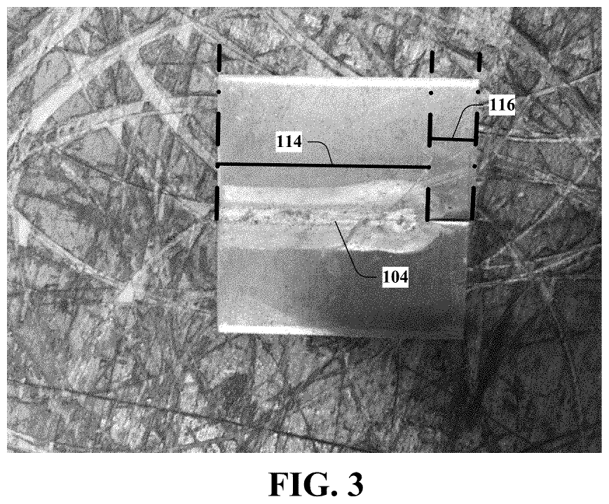

A welding system (discussed in more detail below) can be utilized to perform a weld between the first member 100 and the second member 102 to create a portion of a tailored blank. In particular, the first member 100 can be positioned such that a first edge of the first member 100 is proximate to and/or aligned with a second edge of a second member 102 to form a joint 106 in accordance with the portion of the tailored blank to be created. As depicted in FIGS. 1-3, the first member 100 and the second member 102 can be positioned in a non-overlapping arrangement. It should be appreciated that in certain embodiments, the first member 100 and the second member 102 can be positioned to be overlapping. It is to be further appreciated that there may be one or more welds to perform to create the tailored blank and/or there may be two or more members to attach. The joint 106 can be welded along a length 108 from a first position on the joint 106 to a second position on the joint 106. The length 108 can include at least one of the entire length of a joint 106 from the first end 110 of the joint 106 to the second end 112 of the joint 106, a length from a first end 110 to a position on the joint 106 between the first end 110 and the second end 112, a length from a position on the joint 106 between the first end 110 and the second end 112 to the second end 112, or a length from a first position to a second position where both positions are along the joint 106 in between the first end 110 and the second end 112. A weld process can be performed by a welding system to form the weld 104 on the joint 106 along a portion of the length 108 such that the length 108 includes a welded portion 114 and an unwelded portion 116. The weld process can be, but is not limited to, formed by friction stir welding, laser welding, or another joining process. It is to be appreciated that the welding process can be selected with sound engineering judgment without departing from the scope of the subject disclosure. A top view of a tailored blank having a representative weld 104 is shown in FIG. 2 and a bottom view of the tailored blank having the representative weld 104 is shown in FIG. 3.

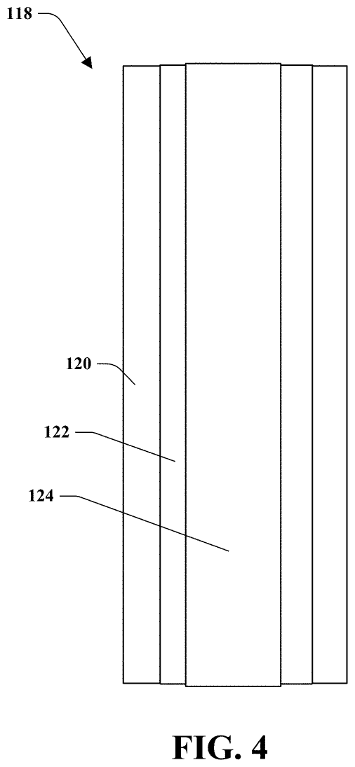

FIG. 4 displays a cross-sectional view of a representative refill friction stir spot welding apparatus 118 (hereinafter refill spot welding apparatus). It is to be appreciated that the techniques of the refill spot welding apparatus can be performed with various tools or devices and such tools and devices can be selected with sound engineering judgment without departing from the scope of the subject disclosure. The welding system that performs a weld between at least the first member 100 and the second member 102 can further utilize a refill spot welding apparatus 118. The refill spot welding apparatus 118 can be utilized to complete the weld 104 for a desired length 108 of the joint 106 by performing a spot weld that covers the unwelded portion 116. The refill spot welding apparatus 118 includes a clamping ring 120 (also referred to as a non-rotating collar), a rotating shoulder 122, and a probe 124. The refill spot welding apparatus 118 can be mounted on a console, coupled to a robotic arm, a table, a fixture, among others and can further be operated by a controller, manually operated, or a combination thereof. In particular, the welding spot apparatus 118, having a cylindrical shape, can be configured with a diameter that corresponds to the length of the unwelded portion 116. In another embodiment, the refill spot welding process can be one or more stations or locations in order to cover a length of the unwelded portion. In other words, the systems and methods can include multiple refill spot welding stations (e.g., side-to-side, within proximity of one another, etc.) to be used to cover and repair the length of the unwelded portion. It is to be appreciated that the shape of the welding spot apparatus 118 can be selected or fabricated with any suitable shape to allow the unwelded length 116 to be at least one of covered, surrounded, or encased by the clamping ring 120. The clamping ring 120 can contact a top surface of both the first member 100 and the second member 102 and provide a downward force to the first member 100 and the second member 102 on a supported table or other fixture to restrain the first member 100 and the second member 102 from movement. Once clamped, the rotating shoulder 122 and the probe 124 can perform the spot weld on the unwelded portion 116 (as described in more detail below). It is to be appreciated that the clamping ring 120 can be selected based on sound engineering judgment and may be include various dimensions (e.g., height, length, width, thickness, size, shape, among others). For example, the clamping ring 120 may be a non-ring shape based on the process or materials for the welding system.

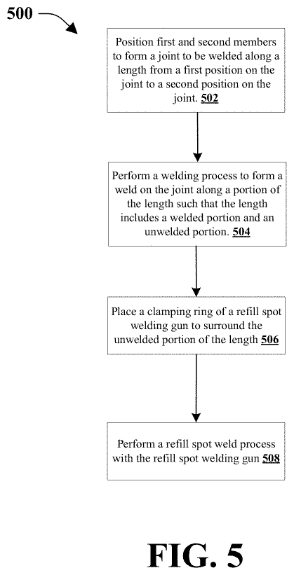

Turning now to FIG. 5, a flow diagram depicting a method 500 of a technique for completing a weld 104 for a length 108 of a joint 106 is illustrated. At reference numeral 502, a first edge of a first member 100 is positioned proximate to a second edge of a second member 102 to form a joint 106. The first edge of the first member 100 and the second edge of the second member 102 can be positioned to be non-overlapping. For example, the first edge and the second edge can be aligned with each other to create a butt joint between the first member 100 and the second member 102. The joint 106 can be welded along a length 108 from a first position on the joint 106 to a second position on the joint 106. As previously described, the first position and the second position can be selected based on sound engineering judgment and may be located anywhere on the joint 106 including the first end 110 of the joint 106, the second end 112 of the joint 106, or any point therebetween. For example, the first position or the second position can be dependent on a shape of the tailored blank the first member and the second member will form.

At reference numeral 504, a welding process is performed to form a weld 104 on the joint 106 along a portion of the length 108 such that the length 108 includes a welded portion 110 and an unwelded portion 112. For example, the weld process can be, but is not limited to, friction stir welding, laser welding, other welding techniques, or another joining process such as brazing or soldering.

At reference numeral 506, the clamping ring 120 of a refill spot welding apparatus 118 is placed to surround the unwelded portion 112 of the length 108. Once placed, the clamping ring 120 functions by contacting the surfaces of both the first member 100 and the second member 102 and applying pressure to clamp the first member 100 and the second member 102 in place. The clamping ring 120 also functions to contain material flow within the clamping ring 120 throughout the refill spot welding process. In certain embodiments, the first member 100 and the second member 102 can be placed on an anvil 126 or other supporting member to provide support to the first member 100 and the second member 102 and to prevent material deformation during the refill spot welding process. In an embodiment, the anvil 126 can be customized with a specific shape based on the welding project or blanks being used. In certain embodiments, the clamping ring 120 of the refill spot welding apparatus 118 is placed to surround only a portion of the unwelded portion 112 of the length 108.

At reference numeral 508, a refill spot welding process is performed with the refill spot welding apparatus 118. In particular, the refill spot welding process can include the steps as follows. The process can include activating the rotating shoulder 122 and the probe to generate heat through friction until the member material reaches a plastic state. It is to be appreciated that the variables (e.g., speed of rotation, rate of movement of probe, time of applying rotation, among others) of the spot welding process can be selected based on the parameters of at least one of the first member 100 or the second member 102. After the member material reaches a plastic state, the method includes retracting the probe 124 while the rotating shoulder 122 plunges into the surface of both the first member 100 and the second member 102. Next, the method includes reversing directions of the rotating shoulder 122 and the probe 124 to return the rotating shoulder 122 and the probe 124 to their starting position. In certain embodiments, the movements of the rotating shoulder 122 and the probe 124 are interchanged such that the rotating shoulder 122 initially retracts and the probe 124 plunges into the surface of the first member 100 and the second member 102. After the shoulder 122 and the probe have returned to the starting position, the method includes releasing the clamping ring 120 from the first member 100 and the second member 102 and removing the refill spot welding apparatus 118 from the first member 100 and the second member 102.

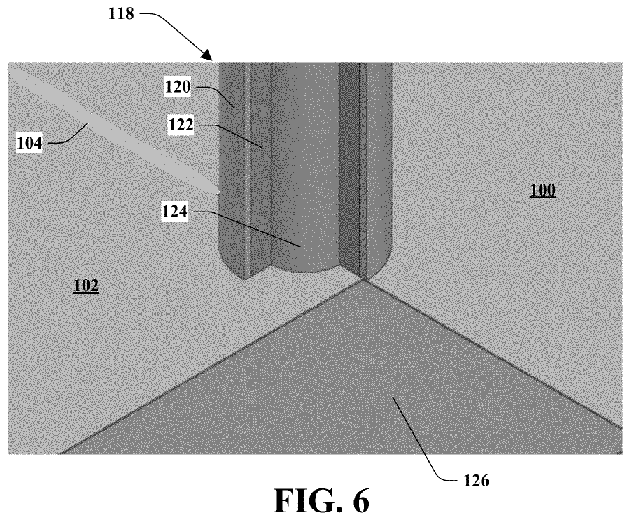

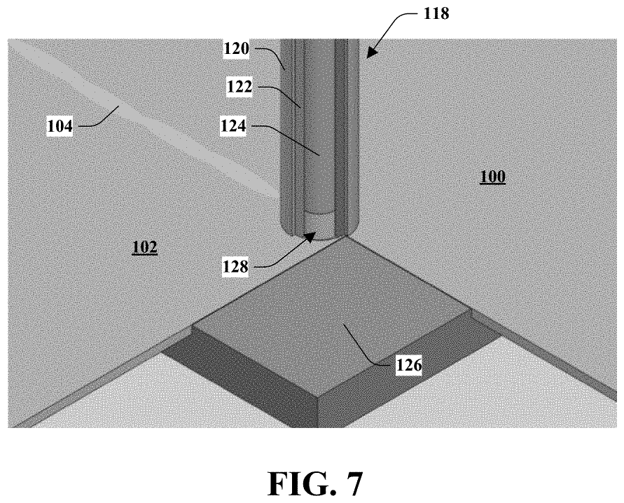

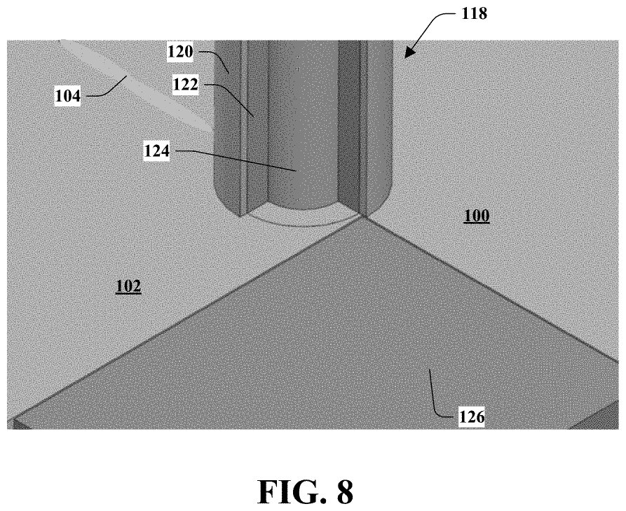

FIGS. 6-9 illustrate the refill spot welding system that performs portions of the method in FIG. 5. It should be appreciated that the system displayed in FIGS. 6-9 is just one example of a system that can be used to perform the method, and can be assembled with sound engineering judgment. As shown in FIG. 6, the rotating shoulder 122 and the probe 124 contact the first member 100 and the second member 102 to surround the unwelded portion 112 of the length 108. In an embodiment, the refill spot welding system can perform the technique in multiple locations, for example, if the probe 124 does not surround the entire unwelded portion 112 of the length 108. The rotating shoulder 122 and the probe 124 generate heat through friction until the member material reaches a plastic state. As shown in FIG. 7, the probe 124 then retracts while the rotating shoulder 122 plunges into the surface of both the first member 100 and the second member 102. The retraction of the probe 124 creates a volume 128 for material displaced by the plunging rotating shoulder 122 to flow. The rotating shoulder 122 and the probe 124 then reverse directions to return to the starting position. During this stage, the probe 124 forces the material back into a cavity formed in the surfaces of the first member 100 and second member 102 by the rotating shoulder 122 while the rotating shoulder 122 is retracting. The rotating shoulder 122 and the probe 124 eventually return to the starting position as shown in FIG. 8.

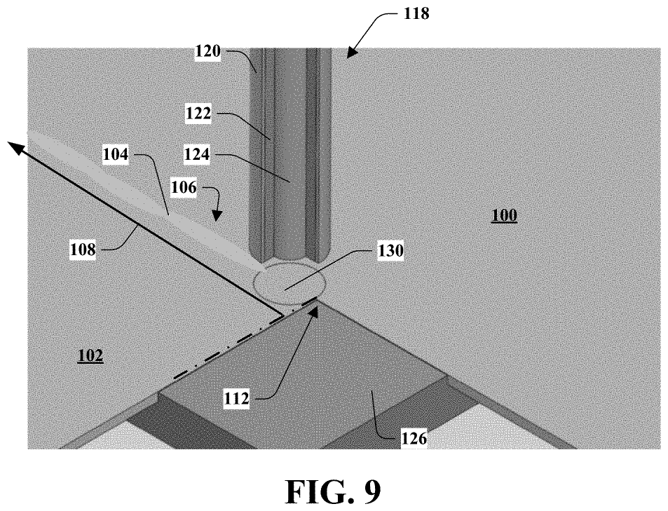

Turning now to FIG. 9, the clamping ring 120 is released from the first member 100 and the second member 102, and the refill spot welding apparatus 118 is removed. The unwelded portion 116 of the length has been welded by the refill spot welding apparatus 118 to complete the weld 104 along the length 108 by forming a spot weld 130. Following the refill spot welding process, the completed weld 104 includes the original welded portion 114 and the spot weld 130. In the embodiment shown in FIG. 9, the spot weld 130 completes the weld 104 for the length 108 that extends to the second end 112 of the joint 106. However, it should be appreciated that the desired length 108 can end at a second position on the joint 106 before the second end 112 of the joint 106.

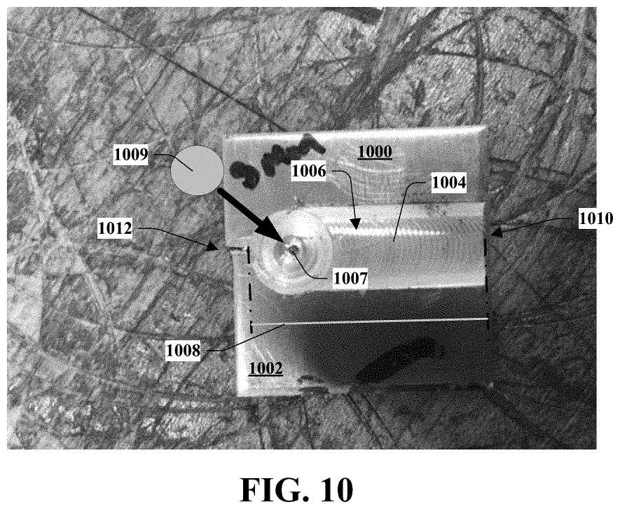

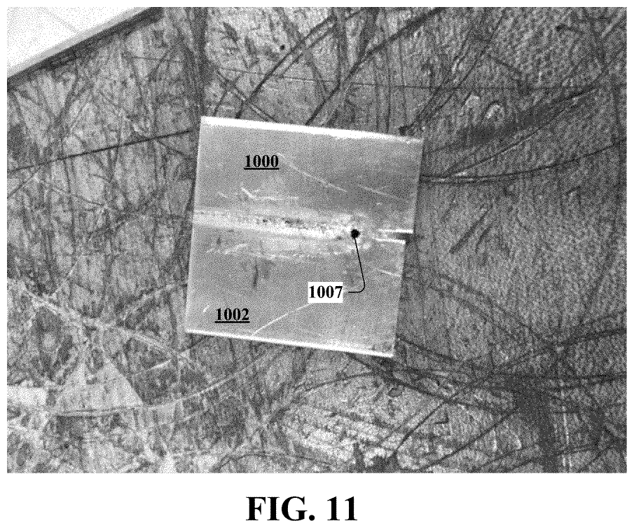

Turning now to FIGS. 10 and 11, in certain embodiments when a first member 1000 and a second member 1002 are joined together at a joint 1006 by a friction stir welding process, a resulting weld 1004 may include a retract hole 1007. FIG. 10 is a top side view of a portion of a tailored blank and FIG. 11 is a bottom view of the portion of the tailored blank. The retract hole 1007 is a result of the material not flowing into the space left from where the friction stir welding tool is retracted at the end of the weld 1004. In these embodiments, additional material 1009 can be added to the retract hole 1007 prior to a refill spot welding process. In an embodiment, the additional material 1009 can be a slug. The additional material 1009 can be made of any material designed to fill the retract hole 1007, including a metal such as aluminum, steel, stainless steel, cast iron, an alloy, or a combination of such materials. In certain embodiments, the additional material 1009 is selected to match the material of the corresponding first member 1000 and/or second member 1002. In other embodiments, the additional material 1009 is selected to differ in material from the first member 1000 and/or second member 1002. The size and shape of the additional material 1009 can be selected using sound engineering judgment, taking into consideration the size of the retract hole, and the diameter of the clamping ring 120 of the refill friction spot welding apparatus 118. In one embodiment, the additional material 1009 is selected to be a shape and size large enough to fill the retract hole once welded, but small enough to be surrounded by the clamping ring 120 of the refill friction spot welding apparatus 118.

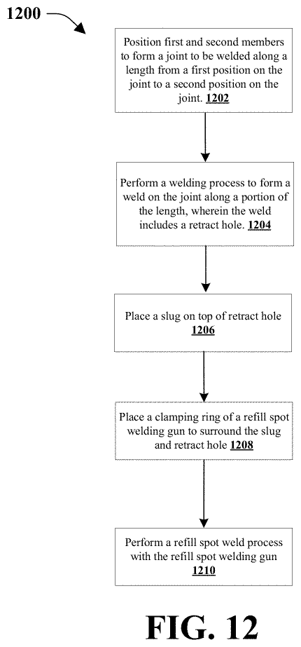

Turning now to FIG. 12, a flow diagram depicting a method 1200 illustrates a technique for completing a weld 1004 having a retract hole 1006. At reference numeral 1202, a first edge of a first member 1000 is positioned proximate to a second edge of a second member 1002 to form a joint 1006. For example, the first edge and the second edge can be aligned with each other to create a butt joint between the first member 1000 and the second member 1002. The joint 1006 is to be welded along a length 1008 from a first position on the joint 106 to a second position on the joint 106. As previously described, the first position and the second position can be selected based on sound engineering judgment and may be located anywhere on the joint 1006 including the first end 1010 of the joint 1006, the second end 1012 of the joint 1006, or any point therebetween.

At reference numeral 1204, a welding process is performed to form a weld 1004 on the joint 1006 along a portion of the length 1008. In certain embodiments, the nature of the welding process creates a weld 1004 with a length 1008 that includes a welded portion 1014 having a retract hole 1007. In an embodiment, the welding process is a friction stir welding process.

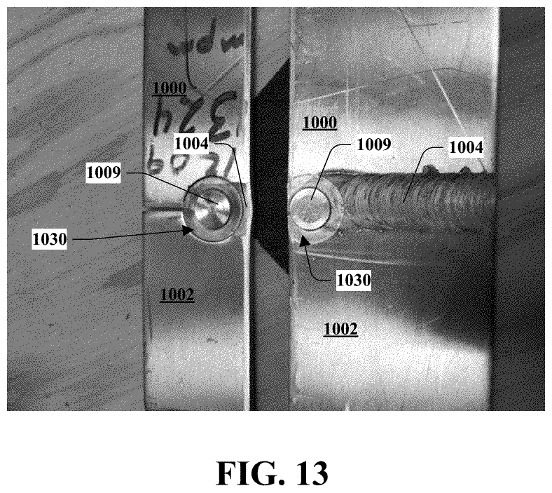

At reference numeral 1206, an additional material 1009 is placed on top of the retract hole 1007. At reference numeral 1208, the clamp ring 120 of a refill spot welding apparatus is placed to surround the additional material 1009 and the retract hole 1007. At reference numeral 1210, a refill spot weld process is performed with the refill spot welding apparatus 120. The refill spot welding process involves the rotating shoulder 122 plunging into the additional material 1009, and in certain embodiments, a portion of the first member 1000 and the second member 1002, which causes the material from the additional material 1009 to fill the volume of the retract hole 1007. FIG. 13 illustrates two examples of a weld 1004 having a refill spot weld 1030 that incorporates the material from the additional material 1009 into the retract hole 1007.

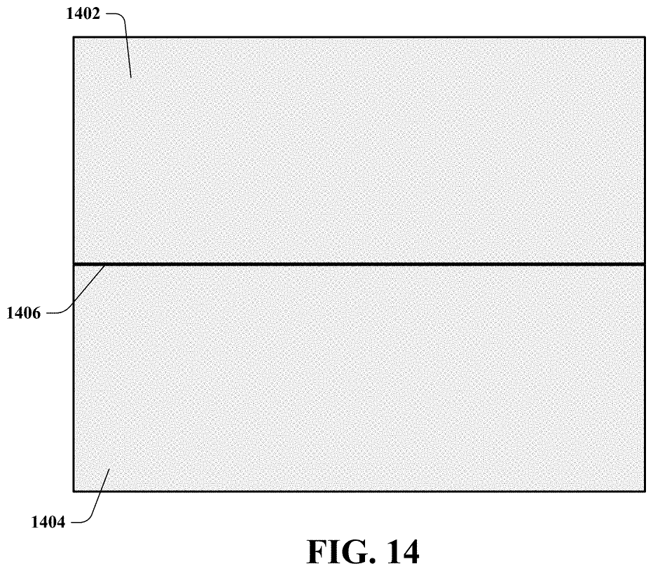

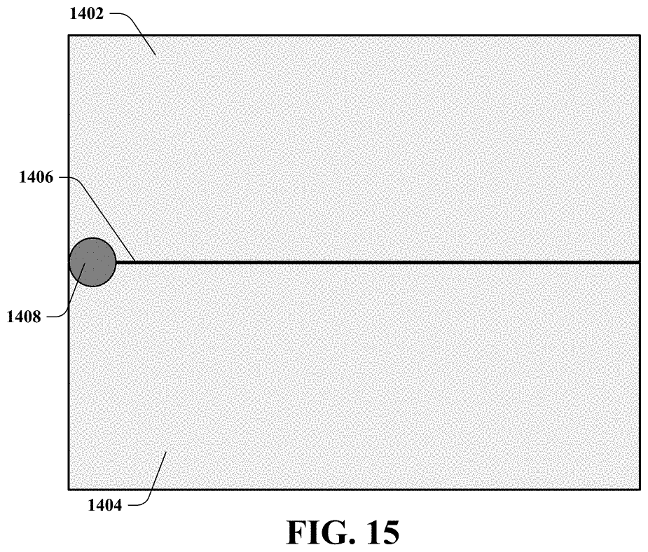

As shown in FIGS. 14-18, multiple refill spot welds can be used to create a weld along a length of a weld joint. Turning now to FIG. 14, a first member 1402 and a second member 1404 are abutted to create a joint 1406. The first member 1402 and the second member 1404 can be positioned to be non-overlapping. It should be appreciated that in certain embodiments, the first member 1402 and the second member 1404 can be positioned to be overlapping. The first member 1402 and the second member 1404 can have the same thickness or different thicknesses. As depicted in FIG. 15, a first spot weld 1408 can be created at a position along the joint 1406. In one embodiment, the first spot weld 1408 is formed at an edge of the joint 1406.

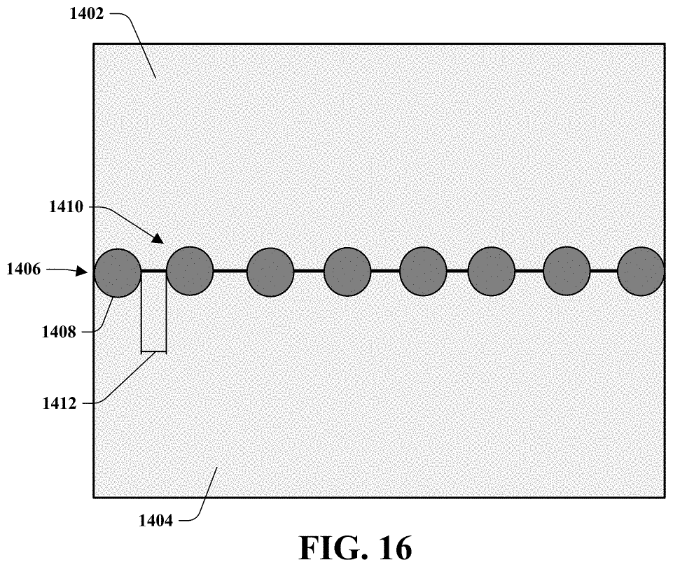

In one embodiment, a length of the joint can be welded with spot welds created in different passes. For example, as shown in FIG. 16, a first set of spot welds 1410 can be created along a length of the joint 1406. The first set of spot welds 1410 includes multiple individual spot welds (e.g. first spot weld 1408) that are staggered to create a gap 1412 between successive individual spot welds along the joint 1406. It should be appreciated that the first set of spot welds 1410 can span the entire length of the joint 1406, or it can span a portion of the entire length of the joint 1406. In certain embodiments, the individual spot welds of the first set of spot welds 1410 can be made by a single spindle welder such as the refill spot welding apparatus 118. In these embodiments, the single spindle (each spindle can include a clamping ring 120, a rotating shoulder 122, and a probe 124) can perform the first spot weld 1408 and then be repositioned at the subsequent locations of the desired welds along the joint 1406. In another embodiment, the first member 1402 and the second member 1404 can be repositioned with respect to the spindle so that the single spindle can perform the subsequent locations of the desired welds along the joint 1406.

In other embodiments, multiple individual spot welds of the first set of spot welds 1410 can be made simultaneously by a refill spot welding apparatus having multiple spindles. In these embodiments, the positions of the multiple spindles can be fixed as to produce a fixed gap 1412, or the positions of the multiple spindles can be adjustable to allow a user to select the size of the gap 1412 between subsequent spot welds of the first set of spot welds 1410. In one embodiment, the position of each spindle on the refill spot welding apparatus can be adjusted individually to allow for varying gap 1412 sizes in between welds. In another embodiment, the position of each spindle is adjusted to create a uniform gap 1412 size in between welds. The spindles can also be swapped out for spindles of varying sizes. For example, the refill spot welding apparatus can be modified to include multiple spindles of different sizes and/or varying sized gaps 1412. In one embodiment, the refill spot welding apparatus having multiple spindles can form the entire first set of welds 1410 simultaneously in one welding operation. In another embodiment, the refill spot welding apparatus having multiple spindles can form a portion of the first set of welds 1410 simultaneously and then be repositioned along the joint 1406 to form a subsequent portion of the first set of welds 1410. In certain embodiments, a refill spot welding apparatus can be modified to allow the addition or removal of spindles. In these embodiments, a user can add or remove spindles to choose and customize the number of spot welds per set of welds. It should be appreciated that the embodiments described above with respect to the creation of the first set of welds 1410 can also be applied to subsequent passes of welds such as, for example, the second set of welds 1414.

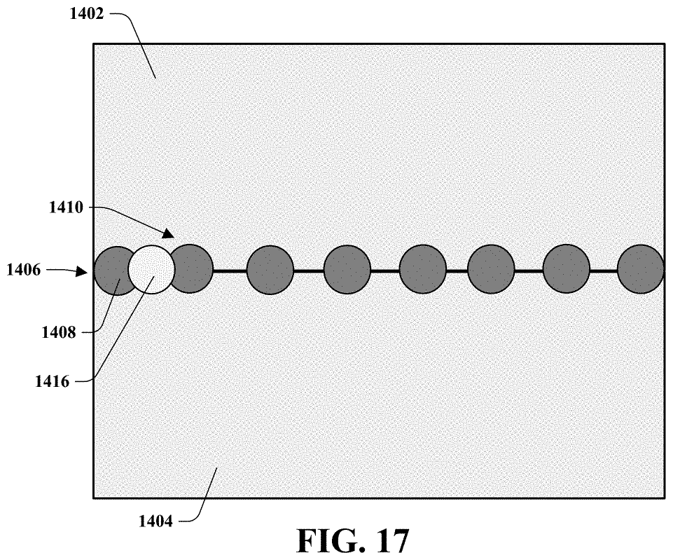

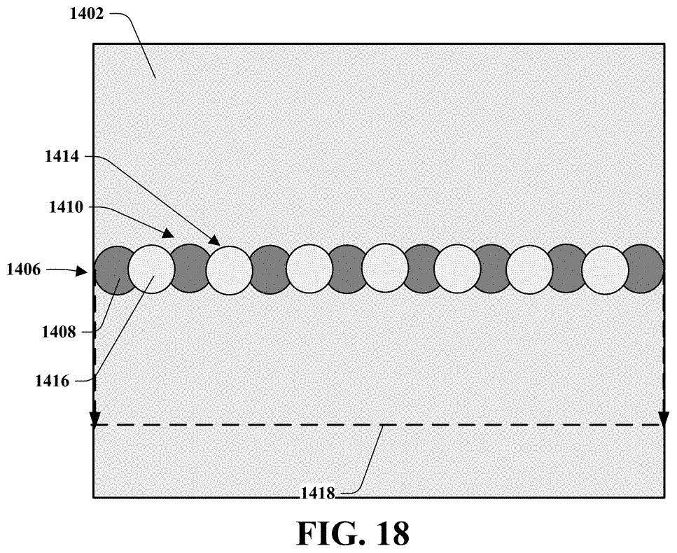

In certain embodiments, additional passes of spot welds can be applied to create a continuous weld. Turning now to FIGS. 17 and 18, a second set of spot welds 1414 can be created along a length of the joint 1406. The second set of spot welds 1414 includes second individual spot welds that are applied to fill in the gaps (e.g. gap 1412) between successive welds of the first set of spot welds 1410. For example, a second spot weld 1416 can be applied adjacent to the first spot weld 1408, or it can be applied overlapping the first spot weld 1408 to at least partially encompass the gap 1412. The second set of spot welds 1414 includes multiple additional spot welds that are applied to fill in the remaining gaps between successive welds of the first set of spot welds 1410, which completes a continuous weld 1418 along the joint 1406. The continuous weld 1418 (e.g. a fully incorporated weld) can therefore span the entire length of the joint 1406 from edge to edge, or it can span a portion of the joint 1406. It should be appreciated that multiple individual spot welds of the second set of spot welds 1414 can be formed with a single spindle welder such as the refill spot welding apparatus 118 or simultaneously by a refill spot welding apparatus having multiple spindles, as discussed above with respect to the first set of welds 1410.

The second set of spot welds 1414 can also be applied in a manner such that the individual welds only partially fill in the gap 1412 between successive welds of the first set of spot welds 1410. In these embodiments, additional passes of welds can be performed in order to complete a continuous weld 1418 along the joint. The larger the gap 1412 between successive welds of the first set of spot welds 1410, the greater the number of weld passes will be needed to completely fill the gaps 1412.

It should be appreciated that the continuous weld 1418 can also be formed in a single pass. In such an embodiment, each successive spot weld of the first set of spot welds 1410 is applied at the edge of a previous spot weld, or overlapping the previous spot weld. In other words, the first set of spot welds 1410 can include individual successive spot welds with no gap 1412 in between.

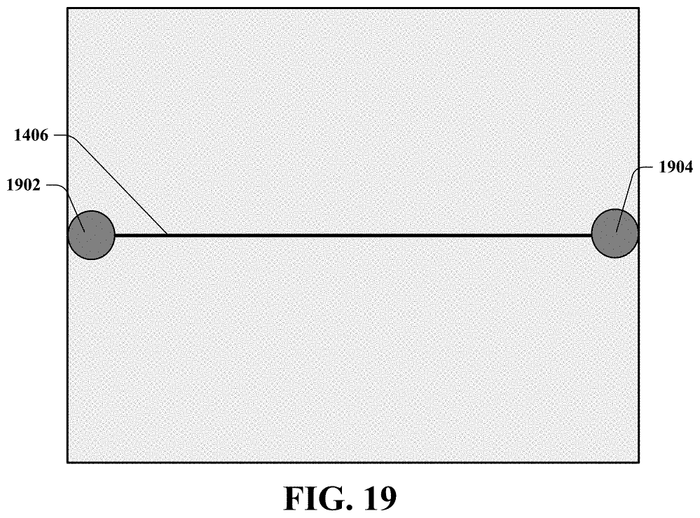

Turning now to FIG. 19, a joint 1406 can be welded using a first end spot weld 1902 applied to a first end of the joint 1406 and a second end spot weld 1904 applied to an opposing end of the joint 1406. In this embodiment, a length of the joint 1406 in between the first end spot weld 1902 and the second spot weld 1904 is unwelded.

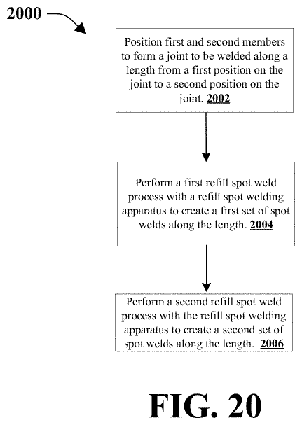

Turning now to FIG. 20, a method 2000 for forming a weld along a length of a joint 1406 is depicted. At reference numeral 2002, a first 1402 and second member 1404 are positioned to form a joint 1406 to be welded along a length from a first position on the joint to a second position on the joint. The first member 1402 and second 1404 can be positioned in a non-overlapping manner. At reference numeral 2004, a first refill spot weld process is performed with a refill spot welding apparatus to create a first set of spot welds 1410 along the length. The first set of spot welds 1410 includes a plurality of first individual spot welds. During the first refill spot weld process, a plurality of gaps 1412 of unwelded material may be left between successive first individual spot welds. At reference numeral 2006, a second refill spot weld process is performed with the refill spot welding apparatus to create a second set of spot welds 1414 along the length. The second set of spot welds 1414 includes a plurality of second individual spot welds that can be positioned to at least partially encompass the plurality of gaps 1412.

It is to be appreciated that various features or aspects of the embodiments described herein can be utilized in any combination with any of the other embodiments.

As utilized herein, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form. Further, as used herein, the term “exemplary” is intended to mean “serving as an illustration or example of something.”

Illustrative embodiments have been described, hereinabove. It will be apparent to those skilled in the art that the above devices and methods may incorporate changes and modifications without departing from the general scope of the claimed subject matter. It is intended to include all such modifications and alterations within the scope of the claimed subject matter. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for forming a weld for a length of a joint, comprising:
positioning a first edge of a first member proximate to a second edge of a second member to form the joint, wherein the joint is to be welded along the length from a first position on the joint to a second position on the joint;
placing a clamping ring of a refill spot welding apparatus to surround an unwelded portion of the length, wherein the clamping ring contacts a top surface of the first member and a top surface of the second member; and
performing a first refill spot weld process with the refill spot welding apparatus to join the first member and the second member at a first spot weld on the joint.

2. The method of claim 1, further comprising:
before placing the clamping ring, performing a welding process to form a portion of the weld on the joint along a portion of the length such that the length includes a welded portion and the unwelded portion.

3. The method of claim 2, wherein the clamping ring is positioned to surround the entire unwelded portion of the length.

4. The method of claim 3, wherein the first refill spot weld process completes the weld along the length from the first position on the joint to the second position on the joint.

5. The method of claim 4, wherein the first position is at a first end of the joint and the second position is at a second end of the joint.

6. The method of claim 4, wherein at least one of the first position or the second position is located between a first end of the joint and a second end of the joint.

7. The method of claim 1, further comprising performing one or more additional spot weld processes with the refill spot welding apparatus to create at least a second spot weld at a different position on the joint from the first spot weld.

8. The method of claim 7, wherein the second spot weld is created at the different position on the joint from the first spot weld, forming a gap of unwelded material between the first spot weld and the second spot weld.

9. The method of claim 7, wherein the first spot weld and the at least second spot weld form the weld along the length of the joint from the first position on the joint to the second position on the joint.

10. The method of claim 1, wherein performing the first refill spot weld process with the refill spot welding apparatus creates a first set of spot welds along the length, wherein the first set of spot welds comprises a plurality of first individual spot welds.

11. The method of claim 10, further comprising:
leaving a plurality of gaps of unwelded material between successive first individual spot welds while creating the first set of spot welds; and
performing a second refill spot weld process with the refill spot welding apparatus to create a second set of spot welds along the length, wherein the second set of spot welds comprises a plurality of second individual spot welds positioned to at least partially encompass the plurality of gaps.

12. The method of claim 1, wherein the refill spot welding apparatus comprises a single spindle.

13. The method of claim 1, wherein the refill spot welding apparatus comprises a plurality of spindles.

14. The method of claim 13, further comprising:
adjusting spindle position of the plurality of spindles on the refill spot welding apparatus prior to performing the first refill spot weld process.

15. A method for forming a weld for a length of a joint, comprising:
positioning a first edge of a first member proximate to a second edge of a second member to form the joint, wherein the joint is to be welded along a length from a first position on the joint to a second position on the joint;
performing a welding process to form the weld on the joint along a portion of the length, wherein the weld includes a retract hole;
placing an additional material on top of the retract hole;
placing a clamp ring of a refill spot welding apparatus to surround the additional material and the retract hole; and
performing a refill spot weld process with the refill spot welding apparatus to fill the retract hole with material from the additional material.

16. The method of claim 15, wherein the additional material comprises a metal selected to match the material of at least one of the first member or the second member.

17. A method for creating a weld for a length of a joint, comprising:
positioning a first edge of a first member proximate to a second edge of a second member to form the joint;
placing at least one clamping ring of a refill spot welding apparatus to surround an unwelded portion of the length, wherein the clamping ring contacts a top surface of the first member and a top surface of the second member; and
performing at least one refill spot weld process with the refill spot welding apparatus to join the first member and the second member at one or more spot welds on the joint.

18. The method of claim 17, wherein the one or more spot welds make up the entire weld.

19. The method of claim 17, wherein the one or more spot welds make up a portion of the weld.

20. The method of claim 17, wherein the refill spot welding apparatus comprises a plurality of spindles.
